(19) United States
(12) Patent Application Publication
(10) Pub. No.: US 2002/0125413 A1
(43) Pub. Date: Sep. 12, 2002

(54) Sensor distribution network

(76) Inventor: Devinder P. Saini, Las Vegas, NV (US)

Correspondence Address: COLIN P ABRAHAMS, 5850 CANOGA AVENUE, SUITE 400, WOODLAND HILLS, CA, 91367

(21) Appl. No.: 09/797,512

(22) Filed: Mar. 1, 2001

(51) Int. Cl. G01B 9/02; G01J 1/04

(52) U.S. Cl. 250/227.14

(57) ABSTRACT

A sensor distribution network for detecting the presence of a target species comprises an optical fiber line having a first end and a second end. A light source is associated with the optical fiber line, and transmits light having two or more wavelengths along the optical fiber line from the near the first end. A detector is provided at or near the second end of the optical fiber line for measuring each wavelength of light reaching the detector. The network includes at least one sensor device located on the optical fiber line, the sensor device comprising a light reflecting member for reflecting light of a predetermined wavelength and a sensor member for receiving the reflected light. The sensor member modulates the reflected light in the presence of the target species.

### FIELD AND BACKGROUND OF THE INVENTION

This invention relates to sensor distribution networks, and sensors used therein.

In one aspect, the invention is for a fiber optic sensor distributed as a network over a large area or distance, whereby the presence of target components can be sensed at various points along the network.

In a specific aspect, the invention relates to the location of sensors at positions along a fiber optic network whereby the presence of target chemicals or substances can be detected at the location of the sensor, and where such detection is analyzed by the network as emanating from a particular sensor.

Various sensors for detecting the presence of target chemical and biochemical compounds are well-known in the art. In a typical application, the sensors involve the use of fiber optic chemistry in which a sensor is located along a fiber optic cable. The light transmitted through the cable by a light source passes though the sensor, and is thereafter analyzed by a detector. Changes in the characteristics of the light signal being received at the detector as a result of the target compound in the vicinity of the sensor can be detected and analyzed. One such sensor may comprise a fiber optic including a layer or covering which is sensitive to the presence of the target chemistry or biochemistry. The coating or layer on the fiber optic forms part of the sensor, and is located in a fiber optic which transmits light from one end to another end which detects light received. In the absence of the target chemical compound, the light received by the detector will be appropriately identified. However, when threshold levels of the target chemical or biochemical compound are present, the coating or layer of target sensitive material on the fiber optic will change the characteristics of the light passing through the fiber optic, and this change will be detected by the detector means.

The sensing layer, or chemistry, on the fiber optic may react in different ways to the presence of the target chemistry, but in all circumstances changes the characteristics of the light traveling down the fiber optic for detection. The sensing chemistry may alter the light in the fiber optic by changes with respect to refractive index, absorption, fluorescence, phosphorescence, and other conventional manners.

One of the problems with conventional systems is that a single fiber optic and sensing chemistry must be present for each area or point at which the target compound is to be detected. Thus, if the presence of, for example, a hydrocarbon leak is to be detected at multiple points, each such point must have its own sensor, fiber optic, light source and detector. It is not possible to have a single fiber optic cable with a plurality of sensors along its length, since any one of those sensors may alter the wave characteristics of the light, but the system would not be able to detect which of the sensors had been activated to change the light characteristic, and therefore pinpoint the leak.

In one aspect, the present invention therefore addresses this problem by providing a sensor distribution network whereby multiple sensors can be placed along a fiber optic cable and the system will be able to detect which of those sensors may be sensing the target chemistry.

Various distributed sensor systems and arrays are shown in the prior art. For example, U.S. Pat. No. 4,770,535 (Kim) describes a distributed sensor array and method using a pulsed signal source. Generally, this patent is for a fiber optic sensor and fiber optic sensor arrays which utilize time division multiplexing in their operation. In summary, the Kim system teaches light pulses sent into an optical fiber which are ultimately coupled back into a second fiber, and thereafter returned to the light source or a photo detector. The invention is essentially a “ladder system” where light pulses are transmitted through the sensors in multiplex form, returning through a ladder. The multiplex systems are received by the optical fiber and a compensating interferometer coherently couples portions of the adjacent multiplex light signals to produce the phase difference representing conditions influencing selective fences. The invention is, in effect, an interferometer where the various sensors cause a phase shift between two arms of an interferometer, causing interference of light to provide certain information as to what may have occurred at the sensor level. The interferometer can only work with devices capable of producing a phase shift within the light source being transmitted within that sensor. Kim requires components which need to be extremely finely organized, tuned and arranged in order to provide the sensing input, with sophisticated instrumentation required in the field or actual sensing areas.

U.S. Pat. No. 4,697,926 (Youngquist) is for a coherent distributed sensor and method using short coherent length sources. This patent shows a system somewhat related to the Kim patent described above, using interferometric techniques which have the same problem as the Kim device.

U.S. Pat. No. 4,699,513 (Brooks) teaches a distributive sensor and method using coherent multiplexing of fiber optic interferometric sensors. Once more, these devices are somewhat similar to that shown in the preceding patents, working on interferometric techniques to do the multiplexing and demultiplexing of the system.

U.S. Pat. No. 5,684,297 (Tardy) is for a method of detecting and/or measuring physical magnitudes using a distributive sensor. The sensor comprises an optical fiber, including an optical core, the core having a plurality of diffraction gratings distributed along the fiber, with each of the diffraction gratings having substantially the same central reflection wavelength in the absence of strain. In this patent, the diffraction gratings used may be Bragg gratings, placed at intervals along the fiber, all of which must be equivalent to each other or identical with each other. The sensor is the Bragg grating itself, and the diffraction grating is not used as a multiplexing or demultiplexing device. The system measures only temperature or strain. Changing the distance between lines of the Bragg grating changes the wavelength that is being reflected back. In Tardy, light reflected back from individual Bragg or diffraction gratings change in wavelength when under strain. The distances are measured using the duration of the pulse, effectively determining how long the pulse took to return from the individual Bragg gratings. In Tardy, the Bragg gratings are not used for reflecting individual wavelengths. In Tardy, the Bragg gratings are all identical to each other, having substantially the same reflection wavelengths, and constituting a measurement point sensitive to changes in the physical magnitude to be monitored.

A publication entitled “A Distributed Fibre Optic Sensor for Hydrocarbon Detection” was presented at the 14^{th} International Conference on Optical Fiber Sensors in Venice, Italy on Oct. 11-13, 2000. In this paper, there is described a sensor called a “distributor fiber optic sensor for hydrocarbon detection”, which comprises a multimode optical fiber, attached to a polymer cable using Kevlar wire. The polymer cable expands when in contact with liquid hydrocarbons. The expansion of the polymer induces a strain into the multimode optical fiber through the Kevlar wrap, causing a loss of light at that point. This loss of light is measured, since it causes a decrease in the intensity, and the measurements are effected using optical time domain reflectometry. The sensor described herein can only detect liquid and not vapors, and would have to come into contact with the liquid hydrocarbon before the sensor was triggered.

### SUMMARY OF THE INVENTION

According to one aspect of the invention, there is provided a sensor distribution network for detecting the presence of a target species, the sensor distribution network comprising: an optical fiber line having a first end and a second end; a light source associated with the optical fiber line, the light source transmitting light having two or more wavelengths along the optical fiber line from the near the first end thereof; a detector at or near the second end of the optical fiber line for measuring each wavelength of light reaching the detector; and at least one sensor device located along the optical fiber line, the sensor device comprising a light reflecting member for reflecting light of a predetermined wavelength and a sensor member for receiving the reflected light, the sensor member modulating the reflected light in the presence of the target species.

According to another aspect of the invention, there is provided a sensor device comprising: a light reflecting member for reflecting light of a specific wavelength only; and a sensor member associated with the reflecting member for receiving light reflected therefrom, the sensor member modulating the reflected light in the presence of a target chemical.

According to yet a further aspect of the invention, there is provided A method for detecting the presence of a target species at predetermined locations, the method comprising: providing an optical fiber line having a first end and second end, and transmitting light along the optical fiber line from the first end to a detector at the second end thereof; locating a plurality of sensor devices at predetermined intervals along the optical fiber line at locations where the target species is to be monitored; reflecting light of a specific wavelength at each of the sensor devices, each sensor device reflecting a different wavelength; transmitting the reflected light through a sensor which modulates light transmission therein in the presence of the target species; and monitoring each wavelength of light transmitted through the optical fiber line for changes in characteristics thereof which may be indicative of the presence of the target species at a specific sensor device.

The present invention is, in one aspect, a fiber optic having at one end a light source, and at the other end a photodetector. Located along the fiber optic there is, preferably at substantially equidistant positions, a plurality of sensors, each sensor including a mechanism for detecting a target species comprising a chemical or biochemical compound. Each sensor location has associated therewith a diffraction grating, preferably a Bragg grating, which is capable of reflecting light of a specific wavelength. In order to function properly, it will be appreciated that the Bragg grating associated with each sensor in the fiber optic sensor line differs from all of the other Bragg gratings in that line, in that it reflects light of a specific wavelength.

Preferably, the light source is a multiple wavelength light source, so that light of different wavelengths are traveling down the fiber optic at any one time. When a light of particular wavelength reaches a Bragg grating in the fiber optic line, that Bragg grating will be configured so as to either reflect that light, if it is for the specific wavelength for which the Bragg grating is configured, or the light will pass right through the Bragg grating and continue on down the fiber optic line until it reaches a Bragg grating which will reflect it.

As an alternative embodiment, the light source is not a multiple wavelength light source, but one which will emit light of various wavelengths only one wavelength at a time. The same situation would apply as described above, namely, that a Bragg grating in the fiber optic line would either reflect the light, if it is of a specific wavelength to which the Bragg grating is set, or allow it to merely pass through.

When the light is of a particular wavelength that is reflected by the Bragg grating, the light will be deflected back from the Bragg grating through a tangential or independent circuit, in which is located a sensor which detects a target species of compound. When the target species is not present, the light, as reflected by the Bragg grating, will pass through the sensor and return to the main fiber optic line, ultimately passing to the photodetector at the remote end of the fiber optic line where it will be analyzed as normal. If, however, the target species is present in or around the sensor, the sensor will react so as to affect, in one way or another, the nature and properties of the light traveling through the fiber optic. The light passing through the sensor is duly changed in its nature by the presence of the target species, and will reach the photodetector where it will be analyzed as indicating the presence of the target species, and therefore trigger an alarm mechanism, as will be described below.

It will be appreciated that the particular sensor from which the altered light wave emanated can be identified and positioned, since the altered light received at the photodetector will be of a particular wavelength connectable to a specific sensor and associated Bragg grating along the optical fiber line. Therefore, the source of the leak of a target species of, for example, hydrocarbon, can be quickly and accurately obtained.

In short, therefore, the invention provides for a single fiber optic cable, capable of having thereon a plurality of sensor devices, each sensor device having associated therewith a Bragg grating which reflects light at a particular wavelength. A change in the property, such as intensity, of light as a result of the presence of the target species can easily be determined by measuring the wavelength of that light, and knowing the position of the particular Bragg grating which reflects that light wavelength.

In this way, it is possible to have a single network or system with one fiber optic, where a target species can be sensed at points over a long distance, and the position of the target species can be identified due to the “customized” Bragg grating/sensor configuration in the fiber optic line.

The sensor distribution network of the invention has a fiber optic which can be distributed over a large or long distance, which may range from several kilometers up to potentially several hundred kilometers, depending upon the nature of the light source as well as the fiber optics being used. Further, according to the invention, a plurality of sensor distribution networks of the invention can themselves be networked together, and light sources and detectors arranged, as will be described more fully below, in order to retain the ability to pinpoint the location of a particular sensor which may be activated by the presence of a target species.

The invention is particularly useful when an array of sensors is set up for a specific application such as pipeline leak detection, where the sensing capabilities must cover long distances and large areas, or when a number of different species need to be detected. Different sensors can be used that are specific to species of interest.

In one embodiment, a multiple wavelength light source is coupled to an optical fiber on which is located a plurality of Bragg grating/sensor hardware devices (1, 2, 3, . . . n), the Bragg gratings reflecting particular wavelengths of light such that when the multiple wavelength light source reaches Bragg grating 1, light of wavelength λ1 in the multiple wavelength light source will be reflected; at Bragg grating 2, light of wavelength λ2 will reflected; at Bragg grating 3, light of wavelength λ3 will be reflected, up to Bragg grating “n” at which light of wavelength λn will be reflected.

At each Bragg grating, a sensor is coupled so as to receive the reflected light from the Bragg grating, and after passing through the sensor, the light then reenters the fiber optic main line for continued transmission therealong. Eventually, the light will reach the photodetector at the far end, where the properties thereof will be analyzed to determine either the presence or absence of the target species.

In the manner described above, a network of sensors can be built up along a single fiber optic cable, with Bragg gratings reflecting light from λ1 to λn, and the detection and analysis will occur at the far end of the fiber optic where the detector is located.

Where the light source is a multiple wavelength light source, which emits light at multiple wavelengths, detection occurs at the far end at the detector using a demultiplexer capable of separating out the individual wavelengths so that their properties and conditions can be detected by several individual photodetectors or a photodetector array to determine the presence or absence of the target species.

If, of course, the light source emits a series of single wavelengths of light one at a time, detection can occur at the remote end using one or a single photodetector, since demultiplexing of the wave from the light source will not be necessary.

With respect to that aspect of the invention which uses a multiple wave length light source, the system further requires the use of a multiplexor and a demultiplexer. Therefore, if there is more than one light signal, or several sources of light, each of which provides a different wavelength, these are all coupled into a single conduit, which would in normal circumstances be the optical fiber, by multiplexing them together, or having the multiple sourcing of the light flowing into one device. At the opposite end of the system, the demultiplexer provides the opposite effect, so that a multiple wavelength light signal traveling along the conduit, or through the optical fiber, will be separated out by the demultiplexer for subsequent analysis as to the presence or absence of the target species.

The present invention is therefore intended to provide a more effective technique of detecting the presence of pollutants, such a hydrocarbons, where, instead of using what is commonly known as “point sensors”, meaning that detection can only take place at one point along the medium used for measuring, multiple point sensing is achieved.

The light source used in the invention is a multiple wavelength light source which should have sufficient power. A preferred light source is a laser diode capable of producing multiple wavelengths. These are commercially available from various sources, and are used often in the communications industry where multiple wavelengths of light need to be produced in a dense wavelength division multiplexing schemes to transmit information along optical fibers. Such laser diodes are created not only for transmitting information, but also for diagnostic purposes.

Laser diodes having an optical spread of wavelengths of about 130 nanometers (nm) are suitable for use within the context of the present invention. The optical spread of 130 nm means that 130 nm of wavelength are available for use in the invention, and these would be suitable for use with Bragg gratings, as described above. Bragg gratings are capable of providing a separation between wavelengths of 0.2 nm. As a result, it is commercially possible to use 0.5 mean nm spread from each wavelength. In other words, if a light source provides a spread of 130 nm, it is possible to individualize wavelengths by half a nanometer from one to the next, and this would provide about 260 wavelengths to make the network of sensors contemplated in the present invention. This means that it will be possible to have up to 260 sensors spread out along the sensor distribution network of the invention. These 260 potential sensors could be individual, discrete sensors, which, if separated by approximately 10 meters, would allow a distribution sensor to cover 2.6 kilometers. Clearly, if the distance between the sensors were to be increased, the distribution sensor network of the invention could cover an even greater length.

In accordance with another aspect of the invention, the sensor distribution network can be made to cover even longer distances by multiplexing a network of secondary fibers, or providing a secondary network of sensors, which can be connected to the original light source by an auxiliary multiplexing scheme. As an example, a first network of sensors could cover the first five kilometers of the length of a pipeline to be monitored, with the second network of sensors covering the second 5 kilometers, thus providing a total of 10 kilometer overall coverage. In this example, the first 5 kilometers of the second network (where the sensors would be located in the second 5 kilometers), would just be an optical fiber, and the two fibers from the first and second networks could be coupled to the same light source using a multiplexing scheme, a wavelength division multiplexer for one or a star coupler, or various other fiber optic coupling devices. Such an arrangement would permit the possibility of sending light into the first network, and then subsequently sending light into the second network. This formula could be applied for a whole number of networks which could provide coverage greater than 10 kilometers, possibly as much a 100 kilometers. Optical fiber amplifying mechanisms can be placed within the fiber itself to compensate for this light loss over the distance. Ultimately, an infinite number of subsystems is feasible. The limitations would be the hardware and the light transmission along the fiber, both of which can be improved over time as more sophisticated or modern hardware is developed.

Generally, distances above 50 kilometers may well require the use of an optical amplification system that boosts the signal, and such a system can be incorporated directly into the fiber itself. However, there are signals which, in certain contexts, allow optical transmissions of up to, and even over, 100 kilometers without need for any amplification of the light signal.

Amplifiers used in the sensor distribution network of the invention may be actually made of the optical fiber itself, or “Erbium doped fiber” which can amplify light signals. The amplification process is fairly straightforward. Light entering the erbium doped fiber stimulates more photons which exit from the erbium doped fiber, and the additional photons are usually obtained by illuminating that section of the fiber with light, such as a light bulb or even sunlight. It is simply an illumination of that particular section of the optical fiber, and any photons coming through that section from the light source of the distribution network of the invention will be appropriately amplified.

The use of a diffraction grating, and particularly a Bragg grating, is central to the present invention, since the Bragg gratings are specifically tailored so that a particular Bragg grating will reflect light of a specific wavelength. Each Bragg grating located in the optical fiber of the distribution network will be differently constructed so as to reflect different wavelengths of light. The Bragg grating reflection is based on Bragg reflection for x-rays from crystals, which follows the equation:

λ=2×N×B

where λ is the wavelength of light reflected, N is the refractive index of the crystal or fiber, and B is the spacing between fiber crystal lattices, or, in this case, the grating lines themselves in the Bragg grating. From this equation, it will be apparent that if the spacing as indicated above is altered, then the wavelength of the light reflected will also be changed. The present invention uses Bragg gratings in a particular distribution network, each with specifically tailored spacings between the lines of the grating itself to make it specific to a particular wavelength of light.

The pattern of Bragg gratings selected for use in the distribution network of the invention is very flexible, and, other than the fact that each Bragg grating should reflect a different wavelength of light from other Bragg gratings in the same fiber optic line, the order, reflected wavelength, and other characteristics of the Bragg gratings is not of particular importance. In assembling the distribution network of the invention, the space between the lines in individual Bragg gratings in the network is calculated, and the specific Bragg grating required produced at the manufacturing level. The Bragg grating can be created as the fiber is being manufactured, or they can be created after the fiber has been manufactured. Customized Bragg gratings are commercially available, so that such Bragg gratings having the correct specifications, as required in the distribution network of the invention, can be easily obtained.

Preferably, the Bragg gratings are placed at substantially equidistant intervals along the fiber optic cable, between the light source and the photodetector. Although equidistant spacing may be preferred, it should nevertheless be appreciated that the Bragg gratings can be appropriately placed along the line at any distance from each other, so that, ultimately, the areas or points requiring the most substantial sensor monitoring are covered. The distance between Bragg gratings may be 10 meters, 20 meters or some other selected distance, and the distance may depend upon the sensitivity of the sensor used in association with the Bragg grating, as well as the number of data points required within the network. The preferred arrangement is that the Bragg grating will be, and should remain, equidistant. In some instances, they could be arranged so that, as they become more and more remote from the light source, they are spaced more closely together in order to maintain light intensity levels, if this should become necessary.

As already described, the light source emits light at particular wavelengths, while each Bragg grating reflects light of a particular wavelength. Once the light source has been selected, the Bragg gratings are set up so that the light source can be separated by 0.5 nm wavelengths at a time.

Any suitable sensor may be used within the context of the invention. In one preferred embodiment, the sensor will be an optical sensor, preferably an optical fiber, which has a chemical coating thereon, the chemical coating changing the light transmission characteristics within the section of that optical fiber when in the presence of the target chemicals. For example, hydrocarbon sensitive coating, when detecting the presence of hydrocarbon, changes its refractive index. Once the refractive index of the coating changes due to the presence of the hydrocarbon, the light transmitted through that section of the fiber will also change due to the relationship of the core and cladding of the fiber and the optical transmission through the fibers. The coating could also be an absorptive coating, which may change color in response to the target species, and at the appropriate wavelength as the color of the coating changes, the light is absorbed into the coating. Another example is the use of fluorescence to change the nature of the light being transmitted through the optical fiber when in the presence of the target species. In fact, any kind of optical change that occurs within the network, or the channel where light is being directed into a smaller network, would be suitable. As long as the sensor is optical in nature, the appropriate measurements can be made.

In a preferred embodiment, the sensor combination comprises a Bragg grating, a sensor, and two couplers for connecting the sensor and Bragg grating in a circuit. The various components can be constructed and/or held together by fusion splicing, or normal connecting techniques. What is essentially being created is a coupler-Bragg grating-coupler relationship, so that light is reflected back from the Bragg grating, passing through the first coupler and into the sensing fiber. The sensor is then connected to the length of main optical fiber which is the normal conduit that is transmitting the light and wavelengths.

In order to ensure the efficient operation of the system, it is important that light reflected back by the Bragg grating is properly channeled, and is not directed back along the optical fiber cable to interfere with the light being emitted from the light source. In this regard, the light source would have an optical isolating system which would stop any reflected light from entering the laser diode, and hence causing instability within the diode.

In determining the presence of the target species, the photodetector or associated instrumentation measures the intensity of light being transmitted through the optical fiber. Therefore, for example, if a particular wavelength of light is reflected from the first Bragg grating, it thereafter passes through the sensor, and back into the optical fiber, and the photodetector notes that no target species is present, with everything normal. The intensity of light received under these circumstances can be termed I₀, and this would be a constant over time. However, when hydrocarbons (or other target species) are present around the sensor, there will be a decrease in the intensity being received at the photodetector due to the loss created by the presence of the hydrocarbons. The intensity of light received would be termed I1. Typically, I₀ would be greater than I1, and the various levels of intensity regarding the presence and amount of hydrocarbons could be determined through a calibration process and system.

Appropriate calibration can be achieved by exposing the sensor to a known concentration of hydrocarbons, and measuring the output intensity for that level of hydrocarbons. That measurement could be considered a standard against which future measurements will be made. Therefore, when the sensor is in the field and in operation, the amount of hydrocarbon can be determined according to a calibration of the intensities based on previous exposure of the sensor, and the concomitant reduction in light intensity which is caused thereby.

As mentioned above, the photodetector would receive a signal of specific intensity for each individual wavelength, and this would be representative of the presence and amount of hydrocarbon at that sensor. The intensity signal could be measured by one photodetector, or multiple photodetectors. Prior information would be available as to the location of each sensor, as well as the wavelength which that particular sensor was using. In a graph plotting intensity versus wavelength, the lines would be normal and constant over time, unless and until hydrocarbons were present and sensed. Hydrocarbons sensed at a particular sensor would result in a decrease in intensity of light leaving that sensor, and there might be detection from adjacent sensors as a result of the propagation of hydrocarbons within the soil or other medium in which the sensors are located. Therefore, it would be possible to determine the location of the hydrocarbons, and the actual intensity decrease would provide information as to the concentration of hydrocarbons present.

The particular purpose of the invention is, of course, the ability to monitor leak detections over long pipelines, such as gasoline or oil pipelines. Once a sensor within the network detects that there are hydrocarbons present around the sensor, thus indicating a leak, the information is stored within a data logging system and may be transmitted back to a home base or computer, or a preselected headquarters, using a radio transmitter, telephone lines and/or low orbit satellites. Once received at the computer, the information may then analyzed by an expert to determine the leak, the distance, the extent of the leak and other relevant data, which can be placed on the Internet. Alarm levels can be set within the data logging system in order that the sensor need not be observed continuously. Appropriately constructed computer software would determine when the intensity level of a specific sensor has fallen below a predetermined level, and trigger the alarm. The alarm may comprise an audio, visual, or other signal, a telephone call, or e-mail message generated by the data analysis system, either at the home base or within the data logging system itself. Preferably, the system in the field would have a minimum amount of electronics and software capabilities, which would be just sufficient so that the data could be appropriately analyzed and transmitted, thereby permitting the more complex, expensive and “intelligent” systems to be in an office or building, and not subject to outdoor conditions and remote maintenance problems.

Although the present invention is able to monitor a considerable distance of pipeline, there are of course limitations as to how many Bragg gratings can be assembled within one line, as well as limitations regarding light traveling down a fiber optic cable. Therefore, the invention contemplates several ways of covering even larger distances. One way would be to have discrete or separate systems, each covering 5-10 kilometers or more, in series or parallel with each other. Each individual system would cover a section of pipeline, with each having its own individual data logger, light source, photodetector, software options, radio transmitter, and other hardware, in order to provide the unique location of any hydrocarbons detected by the sensor. This hardware would transmit information for that section of pipeline only, and a number of such systems would monitor the total pipeline distance. Once data are received at the home office, each transmitter would have its own unique serial number indicating which section of pipeline is being covered, so that the combination of such serial numbers, together with the individualized Bragg grating within that system, would provide extremely accurate data with respect to the location of any leak detected.

In another embodiment of the invention, multiplexing from a single optical source can provide several networks, each network spanning a set distance. Thus, a first network would sense the first 5 kilometers, a second network the next 5 kilometers, and so on. The single optical source would provide light for all of these networks. This system has the advantage of requiring only one discrete device, but would be capable of covering hundreds of kilometers.

The detector is the device which receives the light signal at the end of the fiber optic and provides the appropriate analysis, examining the light intensity for the purposes of determining the presence of target species. The detector itself may be of the multiple or single wavelength type.

A multiple wavelength light source is able of emit all the appropriate wavelengths of light at one time, and make all the measurements at one time. This is possible because individual Bragg gratings would reflect individual wavelengths into their associated sensors. These would be returned into the main fiber optic, and at the remote or distal end, the signals could be analyzed by a photodetector or a number of photodetectors. If all the wavelengths are being transmitted at the same time, they must be separated out at the far end so that the intensity of individual wavelengths can be measured. This would require demultiplexing, as well as the appropriate number of photodetectors. If, for example, 260 different wavelengths are being transmitted and used, the system will require 260 photodetectors to make the measurement at the same time. This is, of course, very costly because of the number of photodetectors and components required. A photodiode array could be used to reduce costs.

In a preferred embodiment of the invention, measuring the intensity of all of the different wavelengths could be achieved using one photodetector, and allowing the multiple wavelength light source to emit one wavelength at a time. This is readily achievable using tunable laser diodes, which permit tuning at particular wavelengths, with very small separation, down to less than 0.2 nanometers. With this arrangement, a light source would transmit a light wave λ1 first, and one photodetector receives that signal. Thereafter, a light wave λ2 would be transmitted, and the same photodetector receives the signal, the signal being separated from the first by time. In order to synchronize the detection end with the emitting end, a long pulse could be sent to start the process, indicating that the subsequent shorter pulses would be λ1 to λn.

In the manner described above, it would be possible to make a sensing device using just one photodetector and multiple wavelengths, at the same time reducing the number of components, complexity of the sensing system, as well as cost.

### BRIEF DESCRIPTION OF THE DRAWINGS

FIG. 1 is a diagrammatic representation of a sensor distribution network in accordance with the invention;

FIG. 2 shows a detailed view of the sensor device which forms part of the sensor distribution network in FIG. 1;

FIG. 3 is an alternative embodiment showing another version of the sensor distribution network of the invention;

FIG. 4 is a diagrammatic representation of a plurality of networks to make up the totality of the distribution network; and

FIGS. 5(a) and 5(b) illustrate schematically fiber optics without and with light transmission changes by the presence of a specific species or analyte.

### DETAILED DESCRIPTION OF THE INVENTION

Reference is made to the various drawings which show different embodiments and versions of the sensor distribution network of the invention.

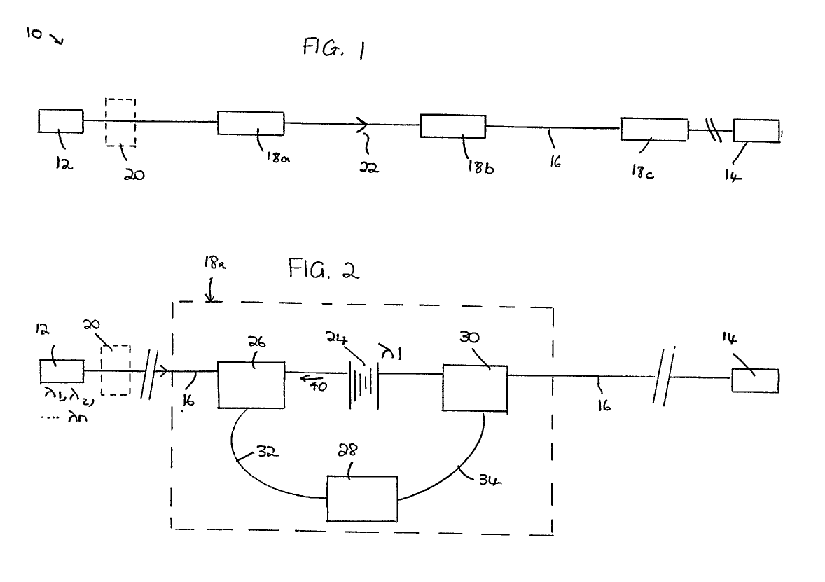

In FIG. 1, there is shown a diagrammatic representation of a sensor distribution network 10, which comprises a light source 12, a photodetector 14 and an optical fiber 16 extending between the light source 12 and photodetector 14. The optical fiber 16 may be of considerable length and distance, up to a number of kilometers or beyond, and may typically run adjacent an oil or gas pipeline or some other form of construction which requires monitoring for pollutants, such as hydrocarbons. Spaced equidistantly along the optical fiber 16 are a series of sensor devices 18a, 18b, 18c. Although only three sensor devices are shown in FIG. 1 of the drawings, there will, in normal applications, be a large number of theses sensor devices 18 located between the light source 12 and the photodetectors 14. The sensor devices 18 are, as mentioned, preferably equidistantly spaced, and may typically be between 5 and 20 meters from each other. However, the invention is not restricted to equidistant spacing between the sensor devices, which may be located along the optical fiber 16 so as to be placed at the necessary locations which best serve the monitoring process.

In FIG. 1, there is shown an optical isolating system 20 which is located immediately downstream of the light source 12 in the optical fiber 16, and is intended to ensure that reflected light along the optical sensor 16 does not return to the light source 12 so as interfere with its functions.

The light source 12 may emit a multi-wavelength light beam, or it may emit, sequentially, a series of single wavelength light beams which travel down the optical fiber 16 in the direction indicated by arrow 22. The light passes through the sensor devices 18a, 18b, 18c, . . . 18n and eventually reaches the photodetector 14 where the nature of the signal is analyzed to determine its intensity or other characteristics. This will indicate whether any hydrocarbon or other pollutant has been detected by a sensor device 18.

With reference to FIG. 2 of the drawings, there is a shown a diagrammatic representation of the sensor distribution network similar to that shown in FIG. 1, but with a detailed illustration indicating the components of the sensor device 18a. The sensor device 18a comprises a Bragg grating 24 which is designed and constructed so as to reflect light of a specific wavelength only. The sensor device 18a further comprises a first coupler 26, a sensor 28 and a second coupler 30. The first coupler 26 is connected to the sensor 28 by optical fiber line 32, and the sensor 28 is connected to the second coupler by optical fiber line 34.

The first and second couplers 26 and 30 are located within the main optical fiber line 16, and, as will be discussed below, permit a tangential or side-circuit, in combination with the sensor 28 and optical fiber lines 32 and 34.

The sensor 28 is positioned at a location where it is best suited to monitor and measure the quantity of hydrocarbon or other pollutant within the medium in which it is located. This medium may be water, air, soil, or any other medium in which a pollutant such as hydrocarbon may be released. The sensor 28 is not restricted to any particular sort, but a preferred embodiment of the sensor would comprise an optical fiber, having a specific coating thereon, with the coating being sensitive to the presence of hydrocarbon so that its properties will change, thereby changing or modulating the nature of the light signal flowing through the sensor.

With reference to FIG. 2, a multiple-wavelength light beam exits from the light source 12, being made up of a number of wavelengths, λ1, λ2, . . . λn. These wavelengths of light may either be emitted simultaneously as a multi-wave light beam, or as a series of single-wave light beams, one after the other. In either event, the light travels down the optical fiber 16, through the optical isolator system to prevent reflected light from returning to the light source, and eventually reaches the first sensor device 18a. As mentioned above, the Bragg grating 24 is designed so as to reflect light having a wavelength of λ1, but all other light of wavelengths λ2 to λn will pass directly through the Bragg grating, and continue on down the path of the optical fiber 16.

The light having wavelength λ1 passing through the optical fiber 16, upon reaching the Bragg grating 24, is reflected back along the optical fiber 16 in the direction of arrow 40, whereupon it reaches the first coupler 26, and is diverted through the optical fiber line 32, through the sensor 28, to the optical fiber line 34, and then back into the second coupler 30. Upon arrival at the second coupler 30, this light of wavelength λ1 continues down the optical fiber 16 until it reaches the photodetector 14.

In this way, light of a specific wavelength is diverted by reflection at each of the Bragg gratings in sensor devices 18a, 18b, 18c, etc. along the optical fiber 16 and through its associated sensor 28. For example, light of wavelength λ2 is diverted by Bragg grating at sensor device 18b, light of wavelength λ3 is diverted by Bragg grating at sensor device 18c, and so on. The sensor 28 at each sensor device 18a etc. is located at a site or point to be monitored for the presence of hydrocarbons.

When no hydrocarbons (or other target species) are present at the sensor 28 of the sensor device 18a, the light of wavelength λ1 passing through sensor 28 will pass back into the optical fiber line 16, and eventually reach the photodetector 14 and the parameters of the light measured. If, however, threshold levels of hydrocarbons are present at this sensor 28, the presence of these hydrocarbons will result in a change or modulation in the nature and/or properties of the light wave of wavelength λ1 returning to the optical fiber 16 through the optical fiber line 34. This modulated light signal will be detected as such at the photodetector 14. The particular wavelength of the light in which the change has been detected will, of course, be measured, so that the location of the sensor device and its Bragg grating reflecting that wavelength of light can be positioned and identified. In this way, therefore, it is possible to pinpoint with considerable accuracy the precise location of any hydrocarbon or other pollutant materials which are leaking from a pipeline or other device being monitored.

It will be appreciated that the sensor devices 18b, 18c etc. are all substantially identical to the sensor device 18a in construction, the only difference being that the Bragg grating in each of the sensor devices 18a, 18b, 18c etc. reflects a different wavelength of light. In any system, each and every Bragg grating located along the optical fiber 16 will have a different wavelength at which it reflects light, thus identifying the particular sensor registering any change in light transmission properties due to the presence of hydrocarbons.

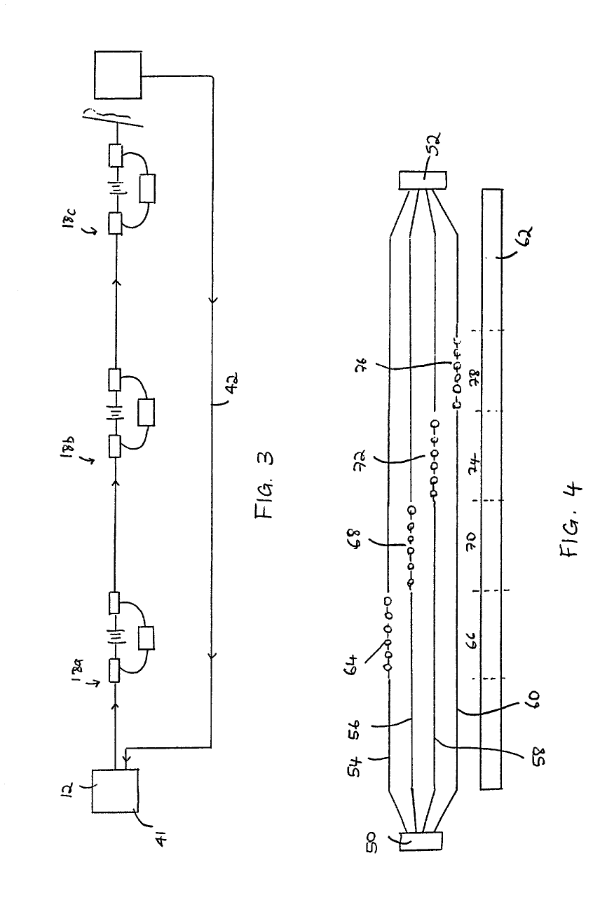

Reference is now made to FIG. 3 of the drawings which shows a slight variation with respect to the embodiment illustrated in FIGS. 1 and 2. In FIG. 3, there is shown a light source, and sensor devices 18a, 18b, 18c etc. In this embodiment, the photodetector forms part of the apparatus or complex in which the light source 12 is located, and the photodetector is identified by reference numeral 41. Therefore, instead of the photodetector being at the remote end of the network, a return optical fiber 42 conveys the light back to the source 12, after it has passed through all of the sensor devices in the line, in which the photodetector is located for analysis and measurement. In this embodiment, most of the necessary hardware required is therefore located at a single point, and in a single device, although, in this case, the return optical fiber 42 in required.

FIG. 4 of the drawings shows yet another diagrammatic representation of a sensor distribution network. In FIG. 4, there is shown a light source 50, at one end, and a photodetector 52 at the other. Extending between the light source 50 and photodetector 52 is a first optical fiber network 54, a second optical fiber network 56, a third optical fiber network 58, and a fourth optical fiber network 60. These networks runs alongside, for example, a pipeline carrying natural gas or oil, indicated by reference numeral 62. The first optical fiber network 54 has a plurality of sensors, indicated generally by reference numeral 64, monitoring and measuring a length 66 along the pipeline 62. The second optical fiber network 56 has a plurality of sensors, generally indicated by reference numeral 68, monitoring and measuring for pollutants along a length of pipeline 70. The third optical fiber network 58 has sensors generally indicated by reference numerals 72, monitoring and measuring the length 74. Finally, the optical fiber network 60, has sensor 76 monitoring and measuring the distance 78. Each of the plurality of sensors in these networks will have a form and construction substantially as described in FIG. 2 of the drawings.

The light source 50 sends out light waves along each one of the optical fiber networks 54, 56, 58 and 60 individually using a multiplexing scheme. Along each network, the light source 50 will include some unique coding or signature element (which can be a series of pulses, for example one long pulse for network 54, two long pulses for network 56, etc.), so that, in the embodiment shown in FIG. 4, the light source 50 will send out four unique signatures for each of the optical fiber networks 54, 56, 58 and 60 respectively.

Each of the Bragg gratings in the sensor devices 64 in the optical fiber network 54 will be configured so as to reflect light of a different wavelength. The same will apply to each of the Bragg gratings in optical fiber networks 56, 58 and 60. However, it will, of course, be possible to overlap the use of Bragg gratings having similar wavelengths at which they reflect light, as long as such Bragg gratings are not located within the same or a single optical fiber network.

The photodetector 52 will therefore receive the light transmission from each of the optical fiber networks 54, 56, 58 and 60, and, the unique signature, together with the specific wavelength particular to a certain Bragg grating, will provide sufficient information so as to pinpoint with accuracy any sensor along the way which may be measuring the presence of a hydrocarbon. Moreover, the arrangement shown in FIG. 4 allows for the monitoring of pollutants over very long distances, since networks can be placed together, and the necessary hardware, namely the same light source 50 and photodetector 52, can be used for each one of the optical fiber networks which are located therebetween.

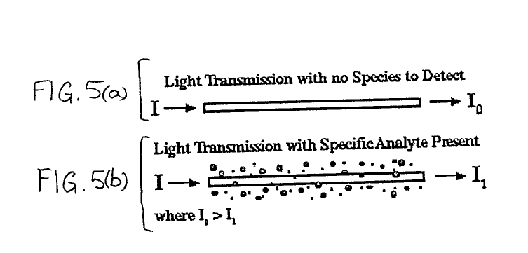

In FIGS. 5(a) and 5(b), there is shown schematically fiber optics without and with light transmission changes by the presence of a specific species or analyte. In FIG. 5(a), a fiber optic transmits light with intensity I and reaches the detector with intensity I0, since no species is present to detect at the sensor and thereby lower this intensity. FIG. 5(b) shows the presence of a species about the sensor along the fiber optic, with the result that intensity I is modulated to intensity I1, where I0>I1, and this decreased light intensity is detected by the photodetector, triggering an alarm as described above.

From the above description, it will be appreciated that the sensor distribution of the network of the invention is a simple and very efficient mechanism whereby a single fiber, single photodetector and single light source may be used to detect target species over a long distance or area. The complexity of the hardware needed in remote areas is significantly reduced, making maintenance and operations much more effective. Of course, the invention is able to replace much more complex systems, as well as individual point detection systems where every sensor requires its own light source and photodetector, as well as a complex method of transmitting data in order to monitor pollutant levels.

Any kind of sensor that is optical in nature may be used in the context if the invention, and no limitations are placed on the invention due to the necessity of using an interferometer or other apparatus which places limitations or restrictions on the nature of the sensing devices.

The invention is not limited to the precise construction details herein described. Various embodiments and modifications within the scope of the claims form part of this invention.

1. A sensor distribution network for detecting the presence of at least one target species, the sensor distribution network comprising:
an optical fiber line having a first end and a second end;
a light source associated with the optical fiber line, the light source transmitting light having two or more wavelengths along the optical fiber line from the near the first end thereof;
a detector at or near the second end of the optical fiber line for measuring each wavelength of light reaching the detector; and
at least one sensor device located on the optical fiber line, the sensor device comprising a light reflecting member for reflecting light of a predetermined wavelength and a sensor member for receiving the reflected light, the sensor member modulating the reflected light in the presence of the target species.

2. A sensor distribution network as claimed in claim 1 comprising a plurality of sensor devices on the optical fiber line, each located at spaced intervals from each other, each light reflecting member in a sensor device reflecting light of a different wavelength from all other light reflecting members in the other sensor devices on the optical fiber line.

3. A sensor distribution network as claimed in claim 1 wherein the light source transmits simultaneously light of multiple wavelength.

4. A sensor distribution network as claimed in claim 1 wherein the light source transmits light of a plurality of wavelengths, one wavelength at a time in a series of bursts.

5. A sensor distribution network as claimed in claim 1 further comprising an optical isolator located on the optical fiber line downstream of the light source for preventing reflected light from re-entering the light source.

6. A sensor distribution network as claimed in claim 1 wherein the detector is a photodetector and includes a demultiplexer for separating out different wavelengths of light, and measuring each wavelength.

7. A sensor distribution network as claimed in claim 1 wherein the photodetector receives light from the optical fiber line one wavelength at a time for measuring changes in the light to determine the presence of the target species.

8. A sensor distribution network as claimed in claim 1 wherein the light reflecting member is a diffraction grating.

9. A sensor distribution network as claimed in claim 1 wherein the light reflecting member is a Bragg grating.

10. A sensor distribution network as claimed in claim 1 wherein the sensor device comprises a Bragg grating for reflecting light of a specific wavelength from the optical fiber line, a first optical pathway for transmitting the reflected light to the sensing member, and a second optical pathway for connecting the sensor member to the optical fiber line so that the reflected light, after passing through the first optical pathway, sensor member, and second optical pathway, re-enters the optical fiber line for onward transmission to the detector.

11. A sensor distribution network as claimed in claim 10 further comprising a first coupling means for coupling the first optical pathway to the optical fiber line, and a second coupling means for connecting the second optical pathway to the optical fiber line.

12. A sensor distribution network as claimed in claim 1 wherein the sensor member comprises a fiber optic having a coating thereon, the coating being reactive to the presence of a target species such that the coating changes its property in the presence of the target species to thereby modulate the light passing through the sensor and through the fiber optic.

13. A sensor distribution network as claimed in claim 1 further comprising amplification means for boosting the intensity of the light signal in the optical fiber line.

14. A sensor distribution network as claimed in claim 1 wherein the light source and detector are located within the same or adjacent housings, and the optical fiber line loops from the light source to the detector.

15. A sensor distribution network as claimed in claim 1 wherein the light source emits light having wavelengths about 0.5 or less nanometers apart.

16. A sensor distribution network as claimed in claim 1 wherein the light source emits light having a wavelength spread of at least 130 nanometers.

17. A sensor distribution network as claimed in claim 1, comprising a plurality of sensor devices arranged along the optical fiber line at spaces equidistant from each other.

18. A sensor distribution network as claimed in claim 12 wherein the components comprising the sensor device are constructed by fusion splicing.

19. A sensor distribution network as claimed in claim 1 comprising a plurality of optical fiber lines each having its own sensor devices located thereon at selected intervals, the plurality of optical fiber lines running substantially parallel to each other and sharing a light source and detector.

20. A sensor device comprising:
a light reflecting member for reflecting light of a specific wavelength only; and
a sensor member associated with the reflecting member for receiving light reflected therefrom, the sensor member modulating the reflected light in the presence of a target chemical.

21. A sensor device as claimed in claim 20 wherein the sensor is mounted on an optical fiber line for transmitting light of multiple wavelengths.

22. A sensor device as claimed in claim 21 wherein the light reflecting member comprises a Bragg grating for reflecting light of a specific wavelength from the optical fiber line, the sensor device further comprising a first optical pathway for transmitting the reflected light to the sensor member, and a second optical pathway for connecting the sensor member to the optical fiber line so that the reflected light, after passing through the first optical pathway, sensor member, and second optical pathway, re-enters the optical fiber line.

23. A sensor device as claimed in claim 22 further comprising a first coupling means for coupling the first optical pathway to the optical fiber line, and a second coupling means for connecting the second optical pathway to the optical fiber line.

24. A sensor device as claimed in claim 20 wherein the sensor member comprises a fiber optic having a coating thereon, the coating being reactive to the presence of a target species such that the coating changes its property in the presence of the target species to thereby modulate the light passing through the sensor and through the fiber optic..

25. A sensor network comprising a plurality of sensors as claimed in claim 20.

26. A method for detecting the presence of at least one target species at predetermined locations, the method comprising:
providing an optical fiber line having a first end and second end, and transmitting light along the optical fiber line from the first end to a detector at the second end thereof;
locating a plurality of sensor devices at predetermined intervals along the optical fiber line at locations where the target species is to be monitored;
reflecting light of a specific wavelength at each of the sensor devices, each sensor device reflecting a different wavelength;
transmitting the reflected light through a sensor forming part of each sensor device so as to modulate light transmission in the presence of the target species; and
monitoring each wavelength of light transmitted through the optical fiber line for changes in characteristics thereof which may be indicative of the presence of the target species at a specific sensor device.

27. A method as claimed in claim 26 wherein a Bragg grating forms part of the sensor device and effects the reflecting of the light.
